(19) United States
(12) Patent Application Publication
(10) Pub. No.: US 2025/0105326 A1
(43) Pub. Date: Mar. 27, 2025

(54) ELECTROLYTE MATERIAL FOR SOLID OXIDE FUEL CELL, PREPARATION METHOD THEREFOR, AND SOLID OXIDE FUEL CELL COMPRISING SAME

(71) Applicant: KOREA ADVANCED INSTITUTE OF SCIENCE AND TECHNOLOGY, Daejeon (KR)

(72) Inventors: Kang Taek LEE, Daejeon (KR); Doyeub KIM, Daejeon (KR); Hyeongmin YU, Daejeon (KR)

(21) Appl. No.: 18/729,697

(22) PCT Filed: Dec. 27, 2022
(86) PCT No.: PCT/KR2022/021406

§ 371 Date: Jul. 17, 2024

(30) Foreign Application Priority Data
Jan. 18, 2022 (KR) 10-2022-0007318

(51) Int. Cl. H01M 8/1253; C01G 29/00; H01M 8/12

(52) U.S. Cl. CPC H01M 8/1253; C01G 29/006; C01P 2002/54; C01P 2002/72; C01P 2006/40; H01M 2008/1293; H01M 2300/0074

(57) ABSTRACT

An embodiment can provide a material for a solid oxide fuel cell, a preparation method therefor, and an electrolyte and a fuel cell each comprising same, wherein the material has ion conductivity by doping of bismuth oxide with erbium (Er), yttrium (Y), and zirconium (Zr), and has excellent durability due to the absence of a reduction in ion conductivity or a phase transition to a rhombohedral-fluorite structure even when the fuel cell is operated at a temperature of 700° C. or lower for a long time.

### TECHNICAL FIELD

The present invention relates to an electrolyte material for a solid oxide fuel cell, and more particularly, to a triple-doped bismuth oxide-based electrolyte usable for a solid oxide fuel cell.

### BACKGROUND ART

A solid oxide fuel cell (SOFC) is a type of a fuel cell that directly converts the chemical energy of fuel into electrical energy through an electrochemical reaction, and is a fuel cell with solid oxide as an electrolyte. This is composed of a porous cathode to which fuel is supplied, a porous anode to which oxygen is supplied, and a solid oxide electrolyte located between the anode and the cathode.

A solid oxide fuel cell operates at high temperatures, and thus has the advantage of higher energy conversion efficiency than a typical heat engine, and operability under pressure, and solid oxide is used as an electrolyte, so that there are no corrosion problems or other operational issues that occur in low-temperature fuel cells that use liquid electrolytes.

In addition, a solid oxide fuel cell is attracting attention as a next-generation power source because it is possible to solve air pollution problems by using hydrogen or hydrocarbon as fuel.

However, solid oxide fuel cells also have limitations. Solid oxide fuel cells require high system costs due to their high operating temperatures, and have problems of insufficient long-term durability.

Lowering the operating temperature to effectively reduce system costs and improve long-term durability is a major task in operating solid oxide fuel cells, and for this, the development of fuel cell materials with high ionic conductivity and durability at intermediate temperatures (ITs<700° C.) is urgent.

From this perspective, when describing electrolytes of solid oxide fuel cells, the main electrolyte types used include yttria-stabilized zirconia (YSZ), gadolinium-doped ceria (GDC), erbium-stabilized bismuth oxide (ESB), and lanthanum gallate with a perovskite structure, and in particular, erbium-stabilized bismuth oxide (ESB) has high ionic conductivity among known oxygen ion conductors and is attracting attention as a high-efficiency solid oxide fuel cell material.

However, these stabilized bismuth oxide (SBO) materials have a problem in that the ionic conductivity decreases over time due to a phase transition to a rhombohedral-fluorite structure or an order-disorder transition of oxygen ions at temperatures below 700° C.

Specifically, when exposed to a temperature of 600° C., a cubic-fluorite structure changes to a rhombohedral-fluorite structure within an hour, and thus there is a limitation that ionic conductivity decreases.

From the same perspective, Korean Patent Publication No. 10-2019-0044234 (Title; Erbium-stabilized bismuth oxide electrolyte with enhanced high-temperature stability through double doping), which is a prior application of the same inventor, discloses an electrolyte, as an ESB electrolyte, for a solid oxide fuel cell, characterized by doping bismuth oxide with erbium oxide as a primary dopant and doping with a metal oxide as a secondary dopant; however, the ionic conductivity is not significantly different from that of ESB, and further improvement is needed.

### RELATED ART DOCUMENT

Republic of Korea Patent Publication No. 10-2019-0044234

### DETAILED DESCRIPTION OF THE INVENTION

### Technical Problem

Another aspect of the present invention is to provide an electrolyte material for a solid oxide fuel cell, a method for manufacturing the same, and a solid oxide fuel cell including the same, wherein the material includes an erbia-stabilized bismuth oxide (ESB) electrolyte, which has high ion conductivity among known oxygen ion conductors and is attracting attention as a high-efficiency solid oxide fuel cell material.

Another aspect of the present invention is to provide a bismuth oxide electrolyte material for a solid oxide fuel cell, a method for manufacturing the same, and a solid oxide fuel cell including the same, wherein the material is triple-doped and has a controlled composition to improve the high ion conductivity of the erbium-stabilized bismuth oxide electrolyte and at the same time suppress a phase transition to a tetrahedral fluorite structure occurring in a stabilized bismuth oxide material, thereby enabling operation of the fuel cell at intermediate temperatures (ITs<700° C.).

The aspect of the present invention is not limited to that mentioned above, and other aspects not mentioned will be clearly understood by those skilled in the art from the description below.

### Technical Solution

As an embodiment of the present invention, an electrolyte material for a solid oxide fuel cell is characterized in that bismuth oxide is doped with erbium (Er), yttrium (Y), and zirconium (Zr) and is represented by Chemical Formula below.

(ErₐY_{b}Bi_{c})₁₋ₓZrₓO [Chemical Formula 1]

(Here, a+b+c=1, and 0<x<1.)

In an embodiment of the present invention, Chemical Formula 1 may satisfy 0.05≤a≤0.1, 0.05≤b≤0.1, and 0.8≤c≤0.9.

In an embodiment of the present invention, Chemical Formula 1 may satisfy 0.01≤x<0.03.

In an embodiment of the present invention, the total doping concentration of erbium (Er), yttrium (Y) and zirconium (Zr) in the electrolyte material may be 10.9 mol % or more and 22.4 mol % or less based on the total mole number.

In an embodiment of the present invention, a crystal structure may be a cubic-fluorite structure at room temperature of 15° C. to 25° C. in the electrolyte material.

In an embodiment of the present invention, after 1,100 hours at 600° C., a crystal structure may maintain a cubic-fluorite structure in the electrolyte material.

In an embodiment of the present invention, ionic conductivity at 700° C. may be 1.0 S/cm or more in the electrolyte material.

As another embodiment of the present invention, a method for manufacturing an electrolyte material for a solid oxide fuel cell may include: (i) mixing a bismuth oxide precursor, an erbium precursor, an yttrium precursor, and a zirconium precursor in stoichiometric amounts;

and (ii) calcining the mixture to dope bismuth oxide with erbium, yttrium, and zirconium to form a compound represented by Chemical Formula below.

(ErₐY_{b}Bi_{c})₁₋ₓZrₓO [Chemical Formula 1]

(Here, a+b+c=1, and 0<x<1.)

In an embodiment of the present invention, the mixing in (i) may be mixing bismuth (Bi) contained in the bismuth oxide precursor in a molar ratio of 77.6 mol % or more and 89.1 mol % or less, erbium (Er) in the erbium precursor in a molar ratio of 4.85 mol % or more and 9.9 mol % or less, yttrium (Y) in the yttrium precursor in a molar ratio of 4.85 mol % or more and 9.9 mol % or less, and zirconium (Zr) in the zirconium precursor in a molar ratio of 1 mol % or more and less than 3 mol %.

In an embodiment of the present invention, the calcining in (ii) may be performed at a temperature of 650° C. or higher and 850° C. or lower.

As another embodiment of the present invention, a solid oxide fuel cell may include the above-described electrolyte material for a solid oxide fuel cell.

### Advantageous Effects

The effect of the present invention according to the above configuration is as follows.

It is possible to provide an electrolyte material for a solid oxide fuel cell, wherein the material has a much higher ionic conductivity than yttria-stabilized zirconia (YSZ), gadolinium-doped ceria (GDC), and erbium-stabilized bismuth oxide (ESB), which are known as electrolyte materials for a solid oxide fuel cell.

In addition, it is possible to provide an electrolyte material for a solid oxide fuel cell, wherein the material does not undergo a phase transition to a tetrahedral fluorite structure, which adversely affects durability and ionic conductivity, even when used for a long period of time at a temperature of 600° C.

In addition, it is possible to provide an electrolyte material for a solid oxide fuel cell, wherein the material maintains ionic conductivity without a decrease even when used for a long period of time at a temperature of 600° C.

The effects of the present invention are not limited to the effects described above, and should be understood to include all effects that are inferable from the configuration of the present invention described in the detailed description or claims of the present invention.

### BRIEF DESCRIPTION OF THE DRAWINGS

FIG. 1 is a flow chart of a method for manufacturing an electrolyte material for a solid oxide fuel cell.

FIG. 2 is data analyzing a crystallographic phase of an electrolyte material for a solid oxide fuel cell.

FIG. 3 is data measuring ionic conductivity of an electrolyte material for a solid oxide fuel cell according to a temperature.

FIG. 4 is data measuring a change in ionic conductivity at 600° C. for 1,100 hours to evaluate long-term durability of an electrolyte material for a solid oxide fuel cell.

FIG. 5 is data analyzing a crystallographic phase after evaluating long-term durability of an electrolyte material for a solid oxide fuel cell.

### MODE FOR CARRYING OUT THE INVENTION

Hereinafter, the present invention will be described with reference to the accompanying drawings. However, the present invention may be implemented in various different forms and, therefore, is not limited to the embodiments described herein. In order to clearly explain the present invention in the drawings, portions unrelated to the description are omitted, and similar portions are given similar reference numerals throughout the specification.

Throughout the specification, when a portion is said to be “connected (linked, contacted, combined)” with another portion, this includes not only a case of being “directly connected” but also a case of being “indirectly connected” with another member in between. In addition, when a portion is said to “include” a certain component, this does not mean that other components are excluded, but that other components may be added, unless specifically stated to the contrary.

The terms used herein are merely used to describe specific embodiments and are not intended to limit the present invention. Singular expressions include plural expressions unless the context clearly dictates otherwise. In this specification, it should be understood terms such as “include” or “have” are to designate the presence of features, numbers, steps, operations, components, parts, or combinations thereof described in the specification, but are not to exclude in advance the possibility of the presence or addition of one or more other features, numbers, steps, operations, components, parts, or combinations thereof.

Hereinafter, an electrolyte material for a solid oxide fuel cell, which is an embodiment of the present invention, will be described in detail.

An electrolyte material for a solid oxide fuel cell, which is an embodiment of the present invention, is expressed by Chemical Formula below, as bismuth oxide is doped with erbium (Er), yttrium (Y), and zirconium (Zr).

(ErₐY_{b}Bi_{c})₁₋ₓZrₓO [Chemical Formula 1]

(Here, a+b+c=1, and 0<x<1.)

Before going into the detailed description of each configuration, the reason why the present invention has the above configuration will be explained.

Pure bismuth oxide has the characteristic of polymorphism and has phases such as α, β, γ, and δ depending on the temperature. Among these, the δ phase existing in the range from 729° C. to the melting point of 824° C. forms an isometric fluorite structure. Since having a high oxygen defect of 25% inherently in an anion lattice, this 8 phase has a very high oxygen ion conductivity of about 1 Scm-1 at 800° C. This value is about 10 times higher than that of gadolinium-doped ceria (GDC) at the same temperature.

However, the δ phase is stable only in a very narrow temperature range, and below the temperature at which the δ phase is maintained, a phase transition occurs into the a phase of a monoclinic structure with very low ion conductivity. In order to prevent this phase transition, if some of bismuth (Bi) in a lattice is replaced with a dopant, the δ phase tends to be stabilized even at low temperatures.

In general, the oxygen ion conductivity of bismuth oxide (SBO) stabilized by doping tends to increase as the ionic radius of the doped dopant increases. On the other hand, the minimum dopant content required to stabilize the δ phase varies depending on the dopant, but the oxygen ion conductivity tends to decrease as the dopant content increases.

Therefore, it is important to dope with an optimized material by considering the effect of the dopant (ionic radius, content, etc.) on the ionic conductivity. In this context, erbium (Er) and yttrium (Y) have been studied previously, and Er_{0.4}Bi_{1.6}O₃ and Y_{0.5}Bi_{1.5}O₃ doped with each material exhibit high ionic conductivity of approximately 0.32 Scm⁻¹ at 700° C.

In order to obtain higher ionic conductivity, studies have been conducted to simultaneously substitute multiple combinations of dopants through a dual doping strategy, and stabilized bismuth oxide (SBO) stabilized in the δ phase through dual doping tended to stabilize the δ phase despite having a lower total dopant content than single doped materials, and showed high ionic conductivity due to low dopant content.

However, the existing dual doping strategy using heterogeneous elements stabilized the δ phase of stabilized bismuth oxide (SBO) up to room temperature, but there was a limitation that a phase transitioned to a rhombohedral-fluorite structure with very low oxygen ion conductivity when the fuel cell was operated at a temperature of 600° C. for 1 hour or more.

In order to overcome this limitation, the present invention attempted a strategy to suppress the phase transition problem by utilizing the advantages of the existing dual doping through triple doping using heterogeneous elements.

Specifically, the electrolyte material for a solid oxide fuel cell, (ErₐY_{b}Bi_{c})₁₋ₓZrₓO (hereinafter, referred to as EYZB), proposed by the present invention has undergone double doping using erbium (Er) and yttrium (Y), which reduces the total dopant content required for stabilizing the δ phase compared to the existing single doping material, thereby improving the oxygen ion conductivity, and thus by doping zirconium (Zr) together, the problem of stabilized bismuth oxide (SBO) undergoing a phase transition to a rhombohedral-fluorite structure with very low oxygen ion conductivity at 600° C. is resolved.

Next, elements adopted for a dopant are as follows.

The biggest factor affecting the oxygen ion conductivity of stabilized bismuth oxide (SBO) is the total dopant content used for stabilizing the δ phase. From this perspective, erbium (Er) was adopted as a dopant candidate because having the lowest total dopant content required for δ-phase stabilization and thus showing the highest oxygen ion conductivity.

Next, factors affecting oxygen ion conductivity of bismuth-based oxide (SBO) are polarizability and ionic radius. The greater these two properties become, the higher the ionic conductivity is. From this perspective, yttrium (Y), which has a relatively large ionic radius and polarizability, was adopted as a dopant.

Next, the reason why zirconium (Zr) was adopted as a dopant is that when a tetravalent metal element such as zirconium (Zr) is doped, a cation interdiffusion coefficient tends to decrease. The decrease in the interdiffusion coefficient means that the rearrangement of cation side reactions may be suppressed, which may suppress a phase transition of stabilized bismuth oxide (SBO) into a rhombohedral-fluorite structure in terms of dynamics. In this regard, the present invention adopted zirconium (Zr) as a third doping element.

Hereinafter, each configuration will be described in detail.

The electrolyte material for a solid oxide fuel cell in the present invention is characterized by triple doping of bismuth oxide (Bi) with erbium (Er), yttrium (Y), and zirconium (Zr), Here, triple doping means that the above-mentioned three types of elements are simultaneously doped to form a compound.

The doping is performed by a process of artificially injecting a dopant by including a diffusion process and an ion implantation process, but it should be interpreted that any process of artificially injecting a dopant may be used in the doping of the present invention without being limited thereto.

In the present invention, the electrolyte material for a solid oxide fuel cell may be expressed by [Chemical Formula 1] below.

(ErₐY_{b}Bi_{c})₁₋ₓZrₓO [Chemical Formula 1]

At this time, a+b+c of Chemical Formula 1 is 1, and x may be greater than 0 and less than 1.

Preferably, Chemical Formula 1 may satisfy 0.05≤a≤0.1, 0.05≤b≤0.1, and 0.8≤c≤0.9, and satisfy 0.01≤x<0.03.

Specifically, when the x value is less than 0.01, the phase change suppression effect by the metal oxide is insignificant, making it difficult to exhibit the phase change stability effect, and when the x value exceeds 0.03, there is a problem that a secondary phase appears in the cubic-fluorite phase.

In addition, when the sum of the a and the b is less than 0.1, the stabilizing effect of the δ phase of stabilized bismuth oxide (SBO) may not be exhibited, and when the sum of the a and the b exceeds 0.2, a decrease in oxygen ion conductivity may occur.

Therefore, it is preferable that Chemical Formula 1 has the values of 0.05≤a≤0.1, 0.05≤b≤0.1, 0.8≤c≤0.9, and 0.01≤x<0.03.

For example, in an example of implementing the present invention, a was adjusted to have a value of 0.06, b was to have 0.06, c was to have 0.88, and x was to have 0.01.

Next, in the present invention, the electrolyte material for a solid oxide fuel cell may have a total doping concentration of erbium (Er), yttrium (Y), and zirconium (Zr) of 10.9 mol % or more and 22.4 mol % or less based on the total mole number.

As specifically described above, multi-doping is more effective in stabilizing the δ phase of stabilized bismuth oxide (SBO) and improving the oxygen ion conductivity even though the total dopant content is lower than that of single doping, so that a total doping concentration of erbium (Er), yttrium (Y), and zirconium (Zr) may be included as 22.4 mol % or less based on the total mole number.

In addition, in order for stabilized bismuth-based oxide (SBO) not to undergo a phase transition to a rhombohedral-fluorite structure at a temperature of 700° C. or lower, zirconium (Zr) must be included in Chemical Formula 1 as 0.01≤x<0.03, and the minimum value of a total doping concentration by erbium (Er), yttrium (Y), and zirconium (Zr) corresponding thereto corresponds to 10.9 mol % of the total mole number.

According to the above configuration, the solid oxide electrolyte material of the present invention is characterized by having a crystal structure of a cubic-fluorite structure at a room temperature of 15° C. to 25° C., and may maintain the crystal structure of the cubic-fluorite structure even after 1,100 hours at 600° C.

In addition, according to the above configuration, the solid oxide electrolyte material of the present invention may have ionic conductivity of 1.0 S/cm or more at 700° C.

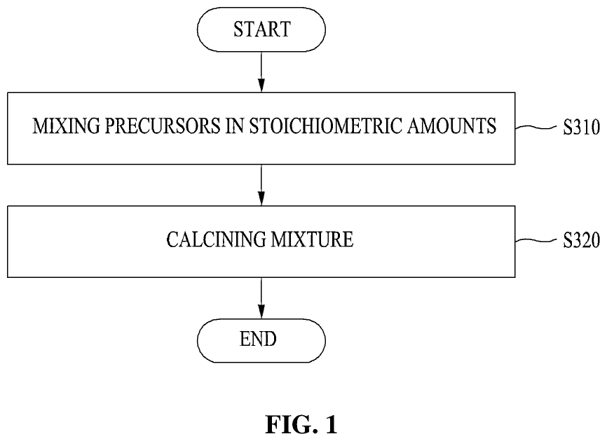

Hereinafter, referring to FIG. 1, a method for manufacturing an electrolyte material for a solid oxide fuel cell, which is another embodiment of the present invention, will be described in detail. In the description, the overlapping configuration with the above-described material for a solid oxide fuel cell should be interpreted identically, and the overlapping description will be omitted.

In the present invention, a method for manufacturing an electrolyte material for a solid oxide fuel cell includes: (i) mixing a bismuth oxide precursor, an erbium precursor, an yttrium precursor, and a zirconium precursor in stoichiometric amounts (S100); and (ii) calcining the mixture to dope bismuth oxide with erbium, yttrium, and zirconium to form a compound represented by Chemical Formula below (S200).

(ErₐY_{b}Bi_{c})₁₋ₓZrₓO [Chemical Formula 1]

(Here, a+b+c=1, and 0<x<1.)

To describe each step in detail, first, (i) (S100) is mixing a bismuth oxide (Bi) precursor, an erbium (Er) precursor, a yttrium (Y) precursor, and a zirconium (Zr) precursor in stoichiometric amounts.

At this time, in the mixing of (i) (S100), the mixing ratio of the bismuth oxide precursor, the erbium precursor, the yttrium precursor, and the zirconium precursor is based on the molar ratio of a dopant, and the molar ratio of the dopant is determined by considering the degree of stabilization of the δ phase according to the total dopant content and the effect of suppressing a phase transition to a rhombohedral-fluorite structure at a temperature of 700° C. or lower.

Accordingly, the mixing of (i) (S100) may be mixing the bismuth (Bi) in an amount of 77.6 mol % or more and 89.1 mol % or less, mixing the erbium (Er) in an amount of 4.85 mol % or more and 9.9 mol % or less, mixing the yttrium (Y) in an amount of 4.85 mol % or more and 9.9 mol % or less, and mixing the zirconium (Zr) in an amount of 1 mol % or more and less than 3 mol %.

Next, the calcining of (ii) (S200) may be performed at a temperature of 650° C. or more and 850° C. or less.

If the calcining temperature is less than 650° C., sufficient energy required for phase formation may not be supplied, so that the cubic-fluorite phase may not be formed, and if the calcining temperature exceeds 850° C., bismuth (Bi) may evaporate. Therefore, it is preferable that the calcining of (ii) (S200) is performed at a temperature of 650° C. or higher and 850° C. or lower.

Hereinafter, an electrolyte for a solid oxide fuel cell and a solid oxide fuel cell including the same, which are other embodiments of the present invention, will be described in detail. In the description, the overlapping configurations with the above-described material for a solid oxide fuel cell and method for manufacturing the same should be interpreted identically, and the overlapping descriptions will be omitted.

In the present invention, the electrolyte for a solid oxide fuel cell and the solid oxide fuel cell including the same correspond to examples of using the electrolyte material for a solid oxide fuel cell, and by including the electrolyte material for a solid oxide fuel cell, it is possible to provide an electrolyte for a solid oxide fuel cell and a solid oxide fuel cell including the same, which have high ionic conductivity and long-term durability even when used at a temperature of 700° C. or lower.

### Manufacturing Example

### (1) Manufacturing of an Electrolyte Material for a Solid Oxide Fuel Cell

### 1) Overview

In order to develop an electrolyte material for a solid oxide fuel cell with high ionic conductivity and long-term stability, it is important to perform doping with an optimized material considering the influence (ionic radius, content, etc.) of a dopant as mentioned above; therefore, prior to identifying the characteristics according to doping, electrolyte materials for a solid oxide fuel cell with different composition ratios were manufactured as an experimental group.

### 2) (i) Mixing a Bismuth Oxide Precursor, an Erbium Precursor, an Yttrium Precursor, and a Zirconium Precursor in Stoichiometric Amounts

With respect to (Er_{0.06}Y_{0.06}Bi_{0.88})₁₋ₓZrₓO, manufactured products had x of 0.01, 0.03, 0.05, and 0.07, respectively, and in the experiments below, the manufactured products were named as shown in Table 1 below.

TABLE 1
Experiment group listing

| | |
|---|---|
| EY1ZB | Er_{0.0594}Y_{0.0594}Bi_{0.8712}Zr_{0.01} |
| EY3ZB | Er_{0.0582}Y_{0.0582}Bi_{0.8536}Zr_{0.03} |
| EY5ZB | Er_{0.057}Y_{0.057}Bi_{0.836}Zr_{0.05} |
| EY7ZB | Er_{0.0558}Y_{0.0558}Bi_{0.8184}Zr_{0.07} |

Manufacturing was performed through a solid-state method, and Er₂O₃ (Alfa Aesar, 99.99%), Y₂O₃ (Alfa Aesar, 99.99%), Bi₂O₃ (Alfa Aesar, 99.9995%), and ZrO₂ (Alfa Aesar, 99.7%) were mixed as precursors in stoichiometric amounts according to the experiment groups in Table 1 above. As for mixing, mixing and grinding were performed for 24 hours through a ball-milling process with zirconia balls, and then ethanol was added and was ground and mixed again through a ball-milling process for 24 hours.

3) (ii) Calcining the Mixture to Dope Bismuth Oxide with Erbium, Yttrium, and Zirconium to Form a Compound

The mixture obtained through the ball-milling process was calcined at 800° C. for 16 hours, the obtained sample was ground using a mortar and pestle, ethanol was added, and then the mixture was mixed and ground again through the ball-milling process for 24 hours to obtain a light yellow powder.

### (2) Manufacturing of a Pellet

The electrolyte material powder for a solid oxide fuel cell obtained according to the manufacturing method was put into a mold, a pressure of 50 MPa was applied using a uniaxial pressing method, and then a pellet was manufactured by performing sintering in a temperature range between 800° C. and 850° C. for 10 hours.

### Experimental Example 1

### Crystallographic Phase Analysis Experiment of an Electrolyte Material Powder for a Solid Oxide Fuel Cell

### (1) Experiment Overview

The experiment was performed to analyze the crystallographic phase analysis of the electrolyte material for a solid oxide fuel cell manufactured according to the manufacturing example above, and the analysis was performed by manufacturing the material in a powder state.

XRD measurements were performed using an X-ray diffractometer (RIGAKU, SmartLab) in the 2θ range of 20° to 80° with Cu Kα radiation (λ=1.5418 Å). The crystal structure of the powder was refined using HighScore software.

### (2) Result Analysis

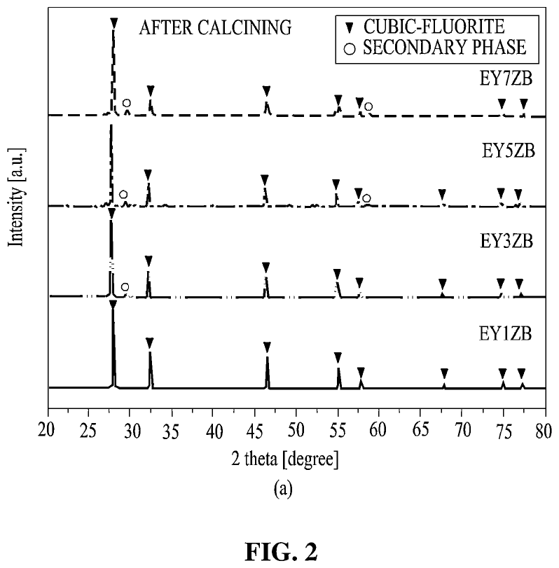

FIG. 2 shows X-ray diffraction patterns of EY1ZB, EY3ZB, EY5ZB, and EY7ZB powders after calcining as the analysis data of this experiment. According to FIG. 2, the EY1ZB powder with a Zr concentration of 0.01 mol % was confirmed to have a cubic-fluorite structure without a secondary phase.

On the other hand, in the XRD patterns of EY3ZB, EY5ZB, and EY7ZB powders, a peak for a secondary phase was confirmed around 2θ 30°.

Therefore, it was confirmed that a stable cubic-fluorite structure bismuth oxide with a total doping concentration of 12% was formed at a Zr concentration of 0.01 mol %.

### Experimental Example 2

Ion conductivity analysis experiment of an electrolyte material for a solid oxide fuel cell

### (1) Experiment Overview

The experiment was performed on the pellet manufactured according to the pellet manufacturing example above to analyze the ion conductivity of an electrolyte material for a solid oxide fuel cell according to a temperature.

The experiment was performed on EY1ZB, which did not show a secondary peak in previous Experimental Example 1, and the ion conductivity of a prepared EY1ZB pellet was measured using a potentiostat (VMP-300, Bio-Logic) in the temperature range of 550° C. to 750° C.

### (2) Result Analysis

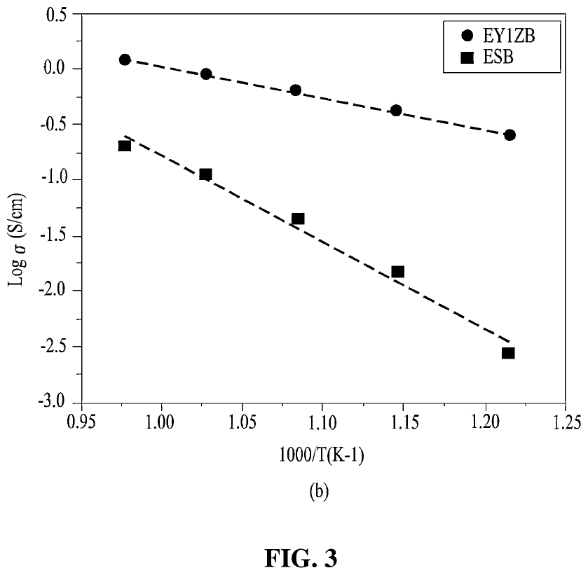

FIG. 3 shows data measuring the ion conductivity of EY1ZB according to a temperature. According to FIG. 3, the ion conductivity of EY1ZB is significantly higher than that of ESB in the temperature range of 550° C. to 700° C. Specifically, the ionic conductivity of ESB was measured to be 0.387 S/cm at 700° C., while that of EY1ZB was measured to be 1.011 S/cm, indicating that the ionic conductivity of EY1ZB was approximately 2.6 times higher than that of ESB.

The improved ionic conductivity of EY1ZB is because while the conventional ESB requires the dopant content of 20% for phase stabilization, EY1ZB requires a lower content of 12%, which better preserves the properties of pure Bi₂O₃.

### Experimental Example 3

### Long-Term Durability Evaluation-Experiment to Measure Ionic Conductivity Changes

### (1) Experiment Overview

The experiment was performed to evaluate long-term durability based on a change in ionic conductivity, and a change in ionic conductivity was measured at 600° C. for 1,100 hours for EY1ZB, which did not show a secondary peak in previous Experimental Example 1.

### (2) Result Analysis

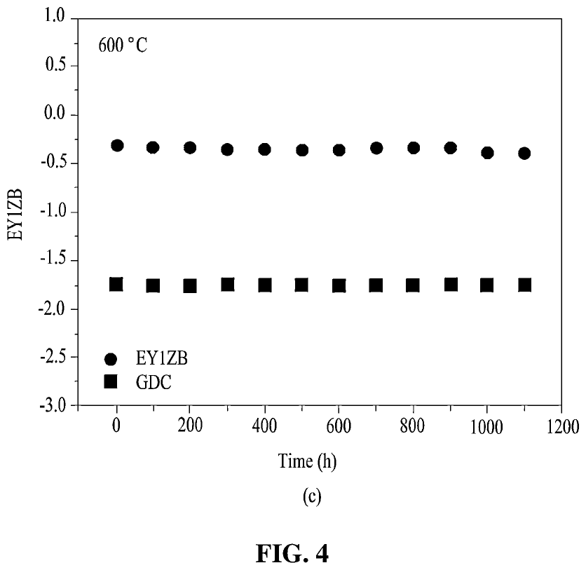

FIG. 4 is data measuring a change in ionic conductivity at 600° C. for 1,100 hours using EY1ZB and gadolinium-doped ceria (GDC), known as an electrolyte material for a solid oxide fuel cell, as a control group.

According to FIG. 4, it was confirmed that the ionic conductivity of EY1ZB was maintained constant without a decrease during the 1,100-hour measurement at 600° C.

Through this, it was confirmed that an electrolyte for a solid oxide fuel cell including EY1ZB suggested in the present invention and a solid oxide fuel cell including the same exhibited stable performance without a decrease in ionic conductivity even when operated for a long time at intermediate temperatures (ITs<700° C.).

### Experimental Example 4

### Long-Term Durability Evaluation-Crystallographic Phase Analysis Experiment

### (1) Experiment Overview

This experiment was performed to confirm that a phase transition to a tetrahedral fluorite structure, which adversely affects durability and ionic conductivity, does not occur even after long-term use, wherein EY1ZB was manufactured in a pellet state and crystallographic phase measurements were performed before and after use at 600° C. for 1,100 hours.

The XRD measurement of a pellet was performed using an X-ray diffractometer (RIGAKU, SmartLab) with Cu Kα radiation (λ=1.5418 Å) in the 2θ range of 20° to 80°, and the crystal structure of the pellet was refined using HighScore software.

### (2) Result Analysis

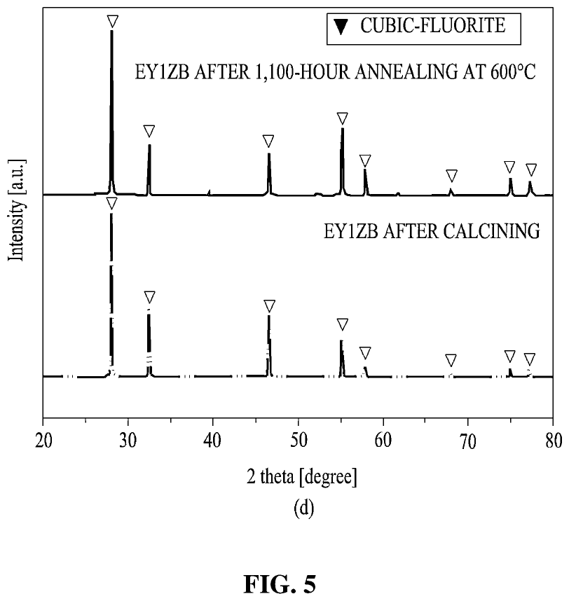

FIG. 5 shows data of X-ray diffraction patterns of an EY1ZB powder immediately after calcining and an EY1ZB pellet after durability evaluation at 600° C. for 1,100 hours. According to FIG. 5, it was confirmed that a cubic-fluorite structure was maintained even after 1,100 hours of durability evaluation at 600° C.

Therefore, it was confirmed that the phenomenon of the cubic-fluorite structure changing to the tetrahedral fluorite structure and the ion conductivity decreasing even after long-term use at a temperature of 600° C. was effectively suppressed through the multi-doping strategy suggested by the present invention.

The description of the present invention described above is for illustrative purposes, and those skilled in the art will understand that the present invention is easily modifiable into other specific forms without changing the technical idea or essential features of the present invention. Therefore, the embodiments described above should be understood in all respects as illustrative and not restrictive. For example, each component described as single may be implemented in a distributed manner, and similarly, components described as distributed may also be implemented in a combined form.

The scope of the present invention is indicated by the claims described below, and all changes or modified forms derived from the meaning and scope of the claims and their equivalent concepts should be construed as being included in the scope of the present invention.

1. An electrolyte material for a solid oxide fuel cell, wherein bismuth oxide is doped with erbium (Er), yttrium (Y), and zirconium (Zr) and is represented by Chemical Formula 1 below.
(ErₐY_{b}Bi_{c})₁₋ₓZrₓO [Chemical Formula 1]
(where, a+b+c=1, and 0<x<1.)

2. The electrolyte material for the solid oxide fuel cell of claim 1, wherein Chemical Formula 1 satisfies 0.05≤a≤0.1, 0.05≤b≤0.1, and 0.8≤c≤0.9.

3. The electrolyte material for the solid oxide fuel cell of claim 1, wherein Chemical Formula 1 satisfies 0.01≤x<0.03.

4. The electrolyte material for the solid oxide fuel cell of claim 1, wherein a total doping concentration of erbium (Er), yttrium (Y) and zirconium (Zr) in the electrolyte material is greater than or equal to 10.9 mol % and less than or equal to 22.4 mol % based on a total mole number.

5. The electrolyte material for the solid oxide fuel cell of claim 1, wherein a crystal structure is a cubic-fluorite structure at room temperature of 15° C. to 25° C. in the electrolyte material.

6. The electrolyte material for the solid oxide fuel cell of claim 1, wherein after 1,100 hours at 600° C., a crystal structure maintains a cubic-fluorite structure in the electrolyte material.

7. The electrolyte material for the solid oxide fuel cell of claim 1, wherein ionic conductivity at 700° C. is greater than or equal to 1.0 S/cm in the electrolyte material.

8. A method for manufacturing an electrolyte material for a solid oxide fuel cell, comprising:
(i) mixing a bismuth oxide precursor, an erbium precursor, an yttrium precursor, and a zirconium precursor in stoichiometric amounts; and
(ii) calcining the mixture to dope bismuth oxide with erbium, yttrium, and zirconium to form a compound represented by Chemical Formula 1 below.
(ErₐY_{b}Bi_{c})₁₋ₓZrₓO [Chemical Formula 1]
(where, a+b+c=1, and 0<x<1.)

9. The method for manufacturing the electrolyte material for the solid oxide fuel cell of claim 8, wherein the mixing in step (i) is mixing bismuth (Bi) contained in the bismuth oxide precursor in a molar ratio of 77.6 mol % or more and 89.1 mol % or less, erbium (Er) in the erbium precursor in a molar ratio of 4.85 mol % or more and 9.9 mol % or less, yttrium (Y) in the yttrium precursor in a molar ratio of 4.85 mol % or more and 9.9 mol % or less, and zirconium (Zr) in the zirconium precursor in a molar ratio of 1 mol % or more and less than 3 mol %.

10. The method for manufacturing the electrolyte material for the solid oxide fuel cell of claim 8, wherein the calcining in step (ii) is performed at a temperature of 650° C. or higher and 850° C. or lower.

11. A solid oxide fuel cell comprising the electrolyte material for the solid oxide fuel cell of claim 1.
